(19) United States
(12) Patent Application Publication
(10) Pub. No.: US 2010/0318446 A1
(43) Pub. Date: Dec. 16, 2010

(54) FLEXIBLE RISK MANAGEMENT FOR PRE-AUTHORIZATION TOP-UPS IN PAYMENT DEVICES

(76) Inventor: Ronald D. Carter, Barrington (GB)

Correspondence Address: BUCKLEY, MASCHOFF & TALWALKAR LLC, 50 LOCUST AVENUE, NEW CANAAN, CT, 06840, US

(21) Appl. No.: 12/481,834

(22) Filed: Jun. 10, 2009

(51) Int. Cl. G06Q 20/00; G06Q 10/00; G06Q 50/00

(52) U.S. Cl. 705/30; 705/41; 705/44

(57) ABSTRACT

A method of operating a payment device includes prompting the user to enter a monetary amount for a top-up request. The method further includes receiving user input into the payment device, where the user input indicates the monetary amount. The method also includes prompting the user to enter a passcode, receiving user input of the passcode in the payment device and verifying the passcode. Still further, the method includes comparing the monetary amount with a risk management parameter, and based on the result of the comparison, determining in the payment device whether to execute the top-up request off-line within the payment device.

### BACKGROUND

Payment cards such as credit or debit cards are ubiquitous. For decades, such cards have included a magnetic stripe on which the relevant account number is stored. To consummate a purchase transaction with such a card, the card is swiped through a magnetic stripe reader that is part of a point of sale (POS) terminal. The reader reads the account number from the magnetic stripe. The account number is then used to route a transaction authorization request that is initiated by the POS terminal. The authorization request is routed from the merchant's acquiring financial institution (“acquirer”) to a server computer operated by or on behalf of the issuer of the payment account. The issuer's server computer provides a response to the authorization request. If the response indicates that the issuer has authorized the transaction, the transaction is consummated at the point of sale. Later the transaction is cleared for settlement via the acquirer and the issuer.

More recently, cards that incorporate an integrated circuit (IC) have been utilized as payment cards. One well known IC payment card standard is referred to as “EMV”, and utilizes an IC card (also known as a “smart card”) that is interfaced to a POS terminal via contacts on the IC card. During a purchase transaction, the payment card account number and other information may be uploaded from the IC payment card to the POS terminal via the IC card contacts and a contact card reader that is included in the POS terminal. Authorization and clearing may then proceed in substantially the same manner as for a transaction initiated with a mag stripe payment card (putting aside additional security measures that may be implemented by using the processing capabilities of the IC payment card).

In other IC payment card systems, the exchange of information between the card and the POS terminal proceeds via wireless RF (radio frequency) communications. These wireless communication payment cards are sometimes referred to as “contactless” payment cards. One example of a contactless payment card standard is referred to in the United States by the brand name “PayPass” and was established by MasterCard International Incorporated, the assignee hereof. It has also been proposed to use wireless exchanges of information via NFC (Near Field Communication) for payment applications.

It has been proposed that the capabilities of a contactless payment card be incorporated into a mobile telephone, thereby turning the mobile telephone into a contactless payment device. Typically a mobile telephone/contactless payment device includes integrated circuitry with the same functionality as the RFID (radio frequency identification) IC of a contactless payment card. In addition, the mobile telephone/contactless payment device includes a loop antenna that is coupled to the payment-related IC for use in sending and/or receiving messages in connection with a transaction that involves contactless payment.

In addition to debit and credit IC payment cards, there are also so-called “prepaid” cards. These cards are not linked to a credit card account or to a bank account from which debits are made via the payment card system. Rather, prepaid cards are loaded (“topped-up”) from time to time with monetary value, and the cards are used to make purchases based on deductions from the value stored in the cards. One advantage of such cards is that the POS terminal does not need to engage in an online transaction to obtain authorization of the pending purchase by way of the payment card system.

When it is necessary to top-up a prepaid card, the card may be interfaced to a terminal or kiosk (by a contact interface or via short-range-contactless-wireless RF communication). The user may interact with the terminal to obtain authorization from a central server to have more monetary value loaded into the prepaid card.

According to still another type of payment system, payment cards or other payment devices that are linked to a credit or debit account may be “pre-authorized” for at least some transactions. For example, according to some practices, an IC payment card may be accepted for “off-line” transactions, say below a certain monetary limit. For off-line transactions, typically the user may be required to provide a PIN (personal identification number) as a form of authentication, but with no requirement for online communication via the payment card system to obtain authorization for the transaction from the issuer of the payment device. The payment device uploads the payment account number to the POS terminal as part of the transaction, and the transaction is later cleared against the credit or debit account via the merchant's acquirer and the account/payment device issuer.

In contradistinction to “off-line” purchase transactions, as described in the previous paragraph, conventional payment system purchase transactions that require real-time online communication with the account issuer—for the purpose of authorization or (in a “one message” system) for immediate charge against the customer's account—may be referred to as “online” transactions.

To the extent that a payment device is used for off-line, pre-authorized transactions, it in effect functionally mimics a pre-paid or stored value card, at least in terms of what occurs at the point of sale.

For risk management purposes, it is customary to impose a limit on the cumulative monetary value of off-line purchase transactions that may be performed with a particular payment device. For example, the payment device may store an “off-line transaction balance”, which may be depleted over time as off-line purchase transactions are executed using the payment device. The off-line transaction balance may thereafter be “topped-up” (i.e., replenished) via an online interaction between the payment device and a server computer operated by or on behalf of the issuer of the payment device. Where the payment device is a contact or contactless card or fob (or the like), the online interaction may take place by interfacing the payment device to a suitable terminal, which accepts user input and forms part of a communication channel between the payment device and the “top-up server”. A well-known standard for such interactions has been established by MasterCard International, Inc. (which is the assignee hereof) in connection with its “M/Chip” program for contact IC payment cards.

Moreover, in a co-pending, commonly assigned patent application Ser. No. 12/481,703 the present inventor (with co-inventors of said commonly assigned application) has disclosed an online process that may be employed for topping-up an offline transaction balance to be carried by a payment-enabled mobile telephone. That '703 commonly-assigned application is hereby incorporated herein by reference. As disclosed therein, the online top-up process utilizes a communication channel that includes over-the-air communication between the top-up server and the payment-enabled mobile telephone.

The present inventor now discloses herein certain techniques that may be employed to provide greater flexibility, convenience and cost-effectiveness in connection with risk management for off-line balances in payment devices.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a block diagram that illustrates a system in which the present invention may be applied.

FIG. 2 is a block diagram that illustrates an embodiment of a server computer that is part of the system of FIG. 1, and that operates in accordance with aspects of the present invention.

FIG. 3 is a block diagram that illustrates a mobile telephone that may be employed as a payment device in connection with the system of FIG. 1 and that is provided in accordance with aspects of the present invention.

FIG. 4 is a block diagram that illustrates some details of the mobile telephone of FIG. 3.

FIG. 5 is a flow chart that illustrates a process that may be performed in the server computer of FIG. 2 in accordance with aspects of the present invention.

FIG. 6 is a flow chart that illustrates a process that may be performed in the mobile telephone of FIG. 3 in accordance with aspects of the present invention.

FIG. 7 is a flow chart that illustrates some details of the process that is illustrated in FIG. 6.

### DETAILED DESCRIPTION

In general, and for the purpose of introducing concepts of embodiments of the present invention, a payment device that is operable for off-line purchase transactions is selectively enabled to replenish its own off-line purchase transaction balance with top-ups that are also “off-line” in the sense that such top-ups do not require contemporaneous interaction between the payment device and a top-up server. Risk management for off-line top-ups in the payment device may be implemented with a risk management parameter that is stored in the payment device and limits the cumulative monetary amount of off-line top-ups that the payment device may perform without engaging in an online interaction with the top-up server. When the payment device reaches the limit (as implemented with the risk management parameter) for off-line top-ups, the next top-up is required to be an online top-up transaction, in which the top-up server interacts with the payment device to increase the off-line transaction balance, and at the same time, the top-up server causes an off-line top up risk management parameter in the payment device to be adjusted to permit further off-line top-ups in the payment device until the off-line top-up limit is reached again.

The payment device may, for example, be a payment-enabled mobile telephone, or a contact or contactless IC payment card or fob or the like.

The off-line top-up risk management parameter may represent an additional risk management tool over and above the risk management implicit in the off-line purchase transaction balance that may be carried in the payment device. With this additional layer of risk management, issuers may, for example, implement more flexible and permissive risk management practices with respect to account holders who are deemed to present lower risks of loss.

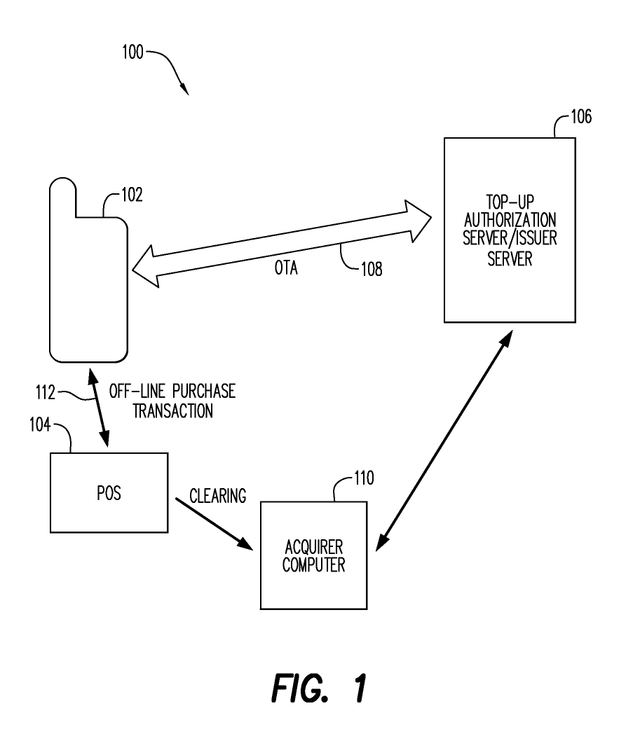

FIG. 1 is a block diagram that illustrates a system 100 in which the present invention may be applied.

The system 100 includes a mobile telephone 102, which includes capabilities for performing payment transactions, as will be seen. That is, the mobile telephone 102 is operable to engage in offline purchase transactions at point of sale (POS) terminals, including a POS terminal 104 shown in FIG. 1.

For purposes of illustration, only one mobile telephone and only one POS terminal are shown in FIG. 1. However, in practice, the system 100 may encompass numerous payment-enabled mobile telephones (belonging to numerous users), and may also include numerous POS terminals capable of handling offline purchase transactions in response to interactions with such mobile telephones. (In addition, at least some of the POS terminals may also be operative to handle offline purchase transactions with conventional prepaid cards and/or with “pre-authorized” payment devices other than payment-enabled mobile telephones. Moreover, the POS terminals may also handle conventional online purchase transactions with contact, contactless, and/or magnetic stripe payment cards. Still further, the system may include a variety of payment devices—not shown—in addition to payment-enabled mobile telephones.)

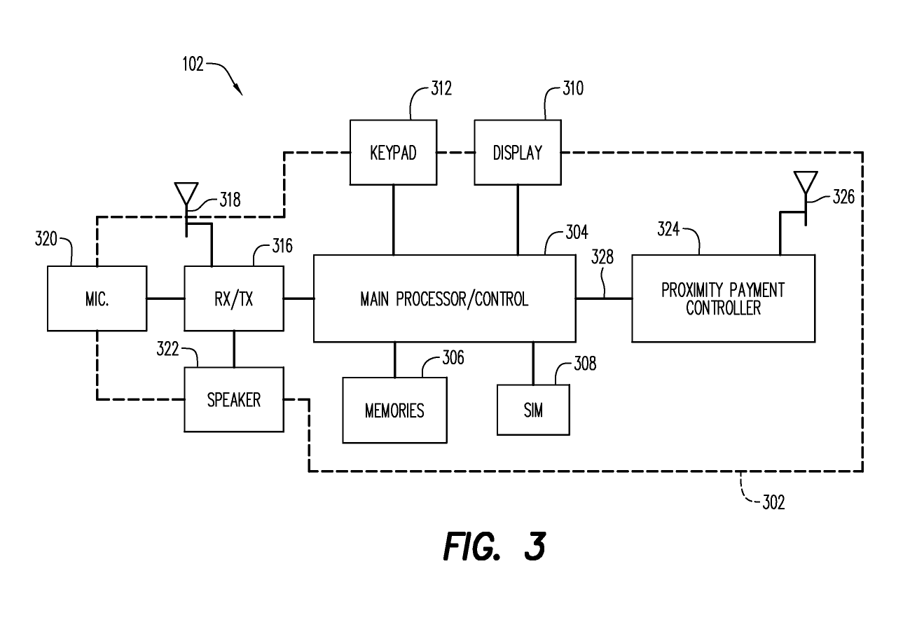

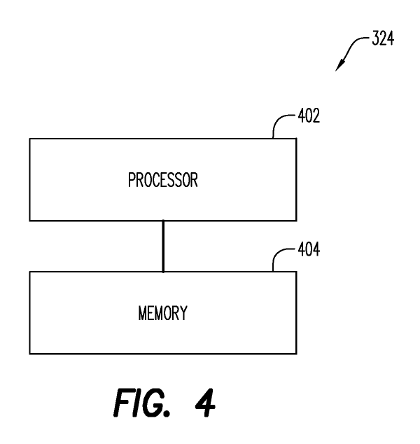

Details of the mobile telephone 102 will be described below in conjunction with FIGS. 3 and 4. The POS terminal 104 may operate in an essentially conventional manner.

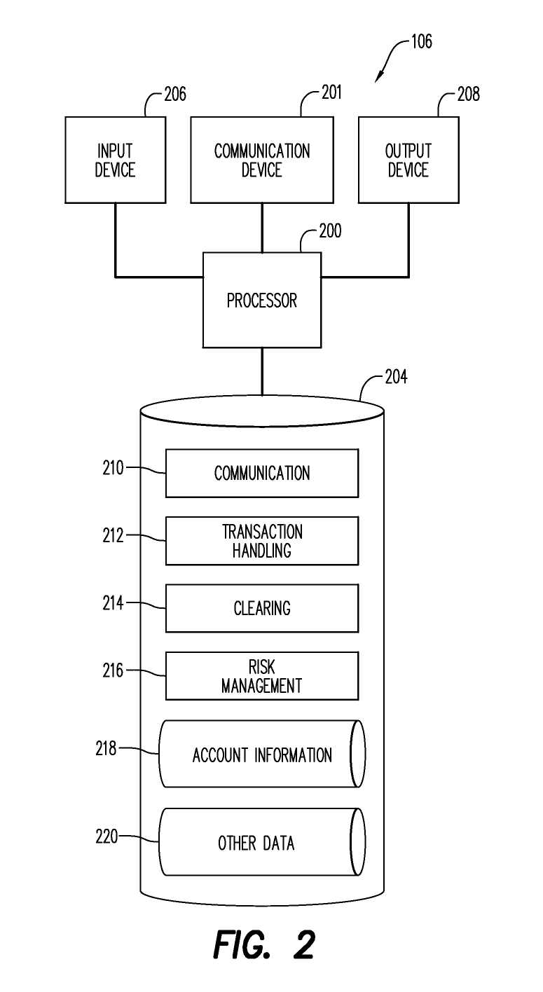

The system 100 also includes a server computer 106. Details of the server computer 106 are provided below in conjunction with FIG. 2. However, to briefly anticipate later discussion, the server computer 106 may be operated by or on behalf of the financial institution (not separately shown) which issued a payment card account to the user of the mobile telephone 102. The server computer 106 handles requests for top-ups from the payment-enabled mobile telephone and other payment devices, and generally manages the user's activities in connection with his/her payment card account.

Again, although only one server computer is shown in the drawing, in practice numerous issuers may participate in the system 100, and accordingly there may be a considerable number of server computers included in the system. However, for a given user, all of his/her transactions in connection with a particular payment card account will result in activity by the particular server computer operated by the issuer of his/her payment card account. Also, as will be seen, the functionality ascribed herein to the server computer 100 may in practice be divided among two or more intercommunicating and cooperating computers. For example, a “front end” server may handle top-up requests, e.g., for customers of an alliance of issuers, or for all issuers in the system. The “front end” server may respond to the top-up requests by referring requests for authorization to various “back office” computers each operated by or on behalf of a particular one of the issuers. More details of such a system are provided in the above-referenced '703 co-pending patent application.

Interactions between the mobile telephone 102 and the server computer 106, including submission and handling of top-up requests, may take place via so-called “over the air” (OTA) communication, as indicated at 108 in FIG. 1.

An acquirer computer 110 is also shown in FIG. 1 as being part of the system 100. The acquirer computer 110 may operate in a conventional fashion to receive from point of sale terminals (or merchant/transaction processor computers coupled to POS terminals) data representing offline purchase transactions handled by the POS terminals. The acquirer computer 110 handles clearing for the offline purchase transactions such that the amounts due to the merchants which operate the POS terminals are transferred from the issuers to the merchants. The acquirer computer 110 may be operated by or on behalf of the financial institution with which the merchant does its banking. In practice, the acquirer computer 110 may also handle conventional online purchase transactions (i.e., purchase transactions that require real-time communication with the card issuers for authorization or the like) where the transactions involve credit or debit cards.

There may be many financial institutions that participate in the system 100 as acquirers. Consequently, the system 100 may include many more acquirer computers than the single acquirer computer that is shown in the drawing.

Before describing some of the components of the system in more detail, an overview of operation of the system 100 will now be provided.

In order for the mobile telephone 102 to engage in an offline purchase transaction, the mobile telephone must first be loaded with a pre-authorized balance. This is done, at least in the first instance, via an “online” top-up transaction in which the mobile telephone 102 and the server computer 106 exchange OTA messages via the OTA communication channel 108. There will be further description below of both online top-up transactions and particularly of off-line top-up transactions which are a particular focus of the present disclosure. A result of each top-up transaction—if allowed to be completed—is to increase the pre-authorized balance stored in the mobile telephone 102.

Thereafter, the user of the mobile telephone visits a merchant and uses the mobile telephone to conduct an offline purchase transaction at the merchant's POS terminal 104. The offline purchase transaction may be performed via a proximity reader (not separately shown) that is associated with the POS terminal 104 and may involve a short-distance wireless exchange of messages between the proximity reader and the mobile telephone 102. By way of example, this exchange of messages may be conducted in accordance with the EMV or PayPass protocols for offline purchase transactions, as indicated at 112 in the drawing. The POS terminal then communicates—directly or indirectly—with the acquirer computer 110 to arrange for clearing of the transaction with the server computer 106, to result in crediting of the transaction amount to the merchant. In the clearing process, communication between the acquirer computer 110 and the server computer 106 may be carried out via a conventional payment system (not shown) such as that operated by the assignee hereof. It should also be understood that the mobile telephone 102 reduces its pre-authorized balance during each off-line purchase transaction in a manner which reflects the amount of the transaction.

FIG. 2 is a block diagram that illustrates an embodiment of the server computer 106.

The server computer 106 may be conventional in its hardware aspects but may be controlled by software to cause it to function as described herein. For example, the server computer 106 may be constituted by conventional server computer hardware.

The server computer 106 may include a computer processor 200 operatively coupled to a communication device 201, a storage device 204, an input device 206 and an output device 208.

The computer processor 200 may be constituted by one or more conventional processors. Processor 200 operates to execute processor-executable steps, contained in program instructions described below, so as to control the server computer 106 to provide desired functionality.

Communication device 201 may be used to facilitate communication with, for example, other devices (such as the mobile telephone 102 and the acquirer computer 110 shown in FIG. 1 or other computers—not shown—with which the server computer cooperates in handling top up requests). For example, communication device 201 may comprise numerous communication ports (not separately shown), to allow the server computer 106 to communicate simultaneously with a number of other computers, including for example computers that implement a payment system by which offline merchant transactions are cleared, and/or which handles conventional online payment card purchase transactions.

Input device 206 may comprise one or more of any type of peripheral device typically used to input data into a computer. For example, the input device 206 may include a keyboard and a mouse. Output device 208 may comprise, for example, a display and/or a printer.

Storage device 204 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 204 stores one or more programs for controlling processor 200. The programs comprise program instructions (which may be referred to as computer readable program code means) that contain processor-executable process steps of the server computer 106, executed by the processor 200 to cause the server computer 106 to function as described herein.

The programs may include a communication application 210 that controls the processor 200 to enable the server computer 106 to engage in data communication with other computers in a conventional manner. The communication application 210 (or a sister application which is not separately indicated) may also control the server computer 106 so as to permit it to exchange data messages and/or to engage in online communication sessions with numerous payment-enabled mobile telephones and/or with other (e.g., IC-card-based) payment devices.

The programs stored in the storage device 204 may also include a transaction handling application 212 that controls the processor 200 to enable the server computer 106 to handle various transactions, including top-up requests and authorization requests for conventional payment card system purchase transactions.

Another program that may be stored on the storage device 204 is a transaction clearing application 214. The clearing application 214 may enable the server computer 106 to respond to clearing requests originating from acquirer computers (e.g., via a payment system which is not shown) to clear both online and offline purchase transactions engaged in by the issuer's customers. In some embodiments, the clearing application 214 may function to clear the offline purchase transactions against so-called “shadow accounts”, which are not separately indicated.

The programs stored on the storage device 204 may further include a risk management application 216. As will be better understood from subsequent discussion, the risk management application 216 may control the server computer 106 to make decisions required in connection with responding to online top-up requests received from payment-enabled mobile telephones and/or other payment devices. Further, as described in detail below, the risk management application 216 may control the server computer 106 to determine whether and to what extent it will issue instructions to the mobile telephones/payment devices to enable such devices to engage in self-administered off-line top-ups of pre-authorized balances.

The storage device 204 may also store, and the server computer 106 may also execute, other programs, which are not shown. For example, such programs may include a billing application, which handles generation of bills to users and which tracks whether payments are received as required. The other programs may also include, e.g., one or more conventional operating systems, device drivers, etc.

The storage device 204 may also store data required for operation of the server computer 106, including data 218 regarding users' payment card account balances and transactions and account terms and conditions and privileges. At least some of this data may be accessed and considered by the server computer 106 in making risk management determinations under the control of the risk management application 216. In addition, reference numeral 220 indicates one or more other databases maintained and utilized by the server computer 106 and stored on the storage device 204.

FIG. 3 is a block diagram representation of the mobile telephone 102, as provided in accordance with aspects of the present invention. The mobile telephone 102 may be conventional in its hardware aspects.

The mobile telephone 102 may include a conventional housing (indicated by dashed line 302 in FIG. 3) that contains and/or supports the other components of the mobile telephone 102. The housing 302 may be shaped and sized to be held in a user's hand, and may for example fit in the palm of the user's hand.

The mobile telephone 102 further includes conventional control circuitry 304, for controlling over-all operation of the mobile telephone 102. Other components of the mobile telephone 102, which are in communication with and/or controlled by the control circuitry 304, include: (a) one or more memory devices 306 (e.g., program and working memory, etc.); (b) a conventional SIM (subscriber identification module) card 308; (c) a keypad 312 for receiving user input; and (d) a conventional display component 310 for displaying output information to the user. (As will be apparent to those who are skilled in the art, a conventional touchscreen, which is not shown, may be included in the mobile telephone 102 in addition to or in place of the display 310 and keypad 3 12.) For present purposes the keypad 312 will be understood to include, e.g., a conventional 12-key telephone keypad, in addition to other buttons, switches and keys, such as a conventional rocker-switch/select key combination, soft keys, and send and end keys.

The mobile telephone 102 also includes conventional receive/transmit circuitry 316 that is also in communication with and/or controlled by the control circuitry 304. The receive/transmit circuitry 316 is coupled to an antenna 318 and provides the communication channel(s) by which the mobile telephone 102 communicates via the mobile telephone communication network (not shown). The receive/transmit circuitry 316 may operate both to receive and transmit voice signals, in addition to performing data communication functions, such as GPRS communications.

The mobile telephone 102 further includes a conventional microphone 320, coupled to the receive/transmit circuitry 316. Of course, the microphone 320 is for receiving voice input from the user. In addition, a loudspeaker 322 is included to provide sound output to the user, and is coupled to the receive/transmit circuitry 316.

In conventional fashion, the receive/transmit circuitry 316 operates to transmit, via the antenna 318, voice signals generated by the microphone 320, and operates to reproduce, via the loudspeaker 322, voice signals received via the antenna 318. The receive/transmit circuitry 316 may also handle transmission and reception of text messages and other data communications via the antenna 318.

The mobile telephone 102 may also include a payment circuit 324 and a loop antenna 326, coupled to the payment circuit 324. The payment circuit 324 may include functionality that allows the mobile telephone 102 to serve as a contactless off-line (pre-authorized) payment device. Details of the payment circuit 324 are shown in block diagram form in FIG. 4.

Referring then to FIG. 4, the payment circuit 324 includes a processor 402. Although shown as separate from the main processor 304 (FIG. 3), the processor 402 may be integrated with the main processor. If separate from the main processor 304, the processor 402 may be in communication therewith (as suggested by connection 328 shown in FIG. 3). In addition or alternatively, the processor 402 may be at least partially provided on the SIM card 308.

Continuing to refer to FIG. 4, the payment circuit 324 further includes a memory 404 that is in communication with the control circuit 402. The memory 404 may be constituted by one or more different devices that store data and/or program instructions, and may overlap at least partially with the memories 306 shown in FIG. 3. (Alternatively, the memory 404 may be separate from the memories 306 shown in FIG. 3.) The memory 404 may store program instructions (which may also be referred to as computer readable program code means) that control the operation of the processor 402 to provide functionality as described herein. The memory 404 may also be referred to as a computer readable medium. In some embodiments, the memory 404 may store a payment application which controls the payment circuit 324 to provide the mobile telephone 102 with payment functionality. Such functionality may include engaging in pre-authorized off-line purchase transactions, and also engaging in online and off-line top-up transactions, as described herein. Moreover, in some embodiments the payment application may also operate to control the mobile telephone 102 for the purpose of engaging in online payment system purchase transactions. In some embodiments, a function of the payment application may be to store the available balance for pre-authorized offline purchase transactions. In some embodiments, the available balance may be effectively stored in terms of two amounts, namely an upper cumulative transaction amount, and an actual cumulative transaction amount, with the available balance being the difference between the two amounts. Consequently, in these embodiments, topping-up may be executed by increasing the upper cumulative transaction amount. As discussed herein, in accordance with aspects of the present invention, top-up transactions may be performed either online, via interaction with the server computer 106, or off-line-i.e., without interaction with the server computer 106.

In some embodiments a “personalization” process may be performed with respect to the mobile telephone 102 to enable it to perform as a payment device. The personalization process may include loading the payment application, and card- and/or user-specific data (e.g., PAN, user name) into one or more memories in the mobile telephone 102. The personalization process may generally be performed in a conventional manner. An example personalization process is described in commonly-assigned U.S. patent application Ser. No. 11/958,695, filed Dec. 18, 2007.

Communications by the payment circuit 324 for the purpose of engaging in off-line and online purchase transactions may be conducted via short range RF communications using the antenna 326. Contrariwise, communications by the payment circuit 324 for the purpose of online top-up transactions may be via the control circuit 304 (if separate from the payment circuit 324) and also via the receive/transmit circuitry 316 and the antenna 318, inasmuch as the online top-up transactions entail OTA communication via the mobile network.

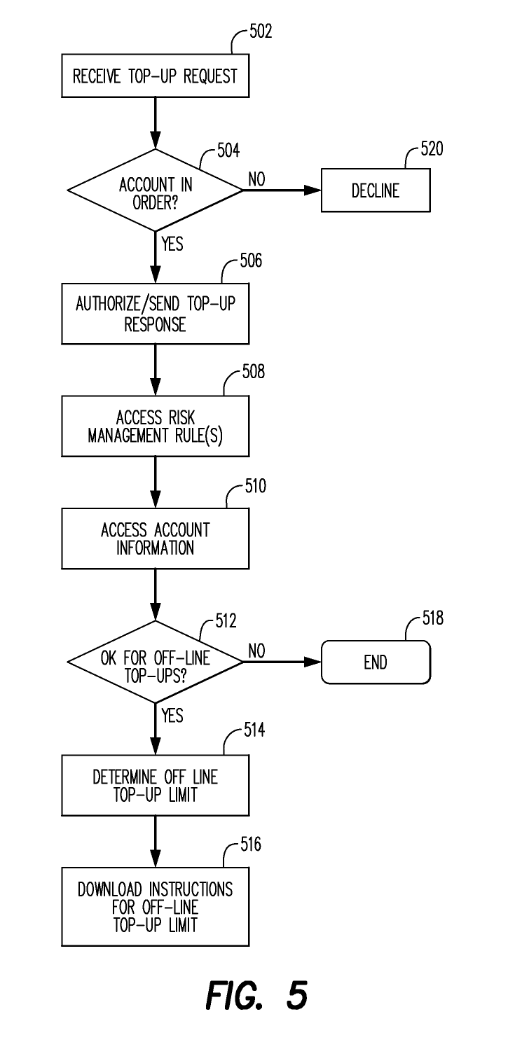

FIG. 5 is a flow chart that illustrates a process that may be performed in the server computer 106 in accordance with aspects of the present invention in connection with an online top-up transaction for a payment device such as the payment-enabled mobile telephone 102.

At 502 in FIG. 5, the server computer 106 receives a request (e.g., in the form of an OTA message) for a top-up transaction from the mobile telephone 102. (In some embodiments, and as discussed below, the server computer 106 may also handle online top-up requests from IC-card-based payment devices.) As is normally the case for a top-up request, the request may specify the amount of the requested top-up, the user's payment account number, and other information as well.

The process of FIG. 5 may advance from 502 to decision block 504. At decision block 504, the server computer 106 may determine whether the condition of the user's account is such that the top-up request can be authorized. For example, the server computer 106 (or another computer to which the server computer 106 submits an inquiry) may determine whether the user's account is in good standing and has sufficient credit available or funds on deposit to support the requested top-up. If so, then the process of FIG. 5 may advance from decision block 504 to block 506. At block 506, the server computer 106 (possibly in conjunction with one or more other computers) may authorize the requested top-up and may transmit a message to the mobile telephone 102 which instructs the mobile telephone 102 to implement the requested top-up by increasing the mobile telephone's stored available balance for off-line purchase transactions. For example, and as described in more detail in the above-referenced '703 patent application, the server computer 106 may transmit a script to the payment application in mobile telephone 102 that causes the payment application to increase an upper cumulative limit for off-line purchase transactions. Alternatively however, the cumulative total of past off-line purchase transactions may be reduced or reset. As still another alternative, and instead of expressing the available pre-authorized balance as the difference between two parameters, the available pre-authorized balance may be expressed directly by a parameter that is reduced by each off-line purchase transaction as it occurs, and that is directly increased by each top-up transaction.

In conjunction with the authorization and implementation of the online top-up, the server computer 106 may also (as indicated by the subsequent blocks in FIG. 5) determine whether and in what amount to permit the mobile telephone 102 to engage in off-line top-up transactions. (As will be apparent from the ensuing discussion, the order in which the process steps are performed may be varied from the order indicated in the drawing.)

Thus, at block 508, the server computer 106 may access one or more risk management rules that guide the server computer 106 in making its determinations with respect to permitting off-line top-ups. Such rules may be programmed into the risk management application 216 (FIG. 2) that was mentioned above, or may be stored in a suitable database. According to one example of such a rule, off-line top-ups may be permitted as long as the user has an overdraft facility that has not been drawn down. According to another example of such a rule, off-line top-ups may be permitted if the user falls into one or more customer privilege categories. According to still another example of such a rule, off-line top-ups may be permitted if the user's account is a credit account, the user's credit limit is above a certain amount, and at least half (or another proportion) of the credit limit is currently uncommitted. Many other types of risk management rules are possible.

Assuming that in a given case the risk management rule(s) indicate(s) that off-line top-ups should be permitted, then one or more other risk management rules may indicate the cumulative amount of off-line top-ups that are to be allowed for the mobile telephone before the next online top-up is required. For example, a risk management rule may permit off-line top-ups cumulating (prior to the next online top-up) to the lesser of $500.00 or half the un-drawn portion of the user's overdraft facility. According to another such rule, off-line top-ups cumulating up to a given amount are permitted to customers in one privilege category, whereas off-line top-ups cumulating to a higher amount are permitted to customers in a different privilege category. Other rules may be provided to aid customers and/or issuers in managing value stored in the mobile telephone.

At block 510, the server computer 106 may access information concerning the user's account in order to determine whether the risk management rule(s) are (is) satisfied. (Block 510 may, for example, be performed before, during or after block 508.) This information may be stored in and accessed from the account information database 218 (FIG. 2) that was mentioned above. The information to be accessed at 510 may include, for example, one or more of the user's account balance, available credit, available amount of overdraft facility, privilege category, etc.

Following blocks 508 and 510 is a decision block 512. At decision block 512, the server computer 106 applies the risk management rule(s) to the user account information to determine whether to permit off-line top-ups for the mobile telephone 102. If the server computer 106 makes a positive determination at decision block 512, then block 514 follows decision block 512. At block 514, the server computer 106 applies one or more risk management rules to the user account information to determine what should now be the limit to the cumulative amount of off-line top-ups permitted before the next online top-up. That limit may be expressed as the value of an off-line top up risk management parameter that is to be set and stored in the mobile telephone 102.

At block 516, the server computer 106 downloads, to the mobile telephone 102, instructions to set the off-line top-up risk management parameter (as mentioned in the previous paragraph) in the mobile telephone 102. In one embodiment, the off-line top-up risk management parameter may be expressed as the difference between two other parameters, namely an upper cumulative limit on off-line top-ups, and a cumulative total of the amounts of off-line top-ups that have been performed in the mobile telephone 102. In some embodiments, the off-line top-up risk management parameter may be increased by increasing the upper cumulative limit on off-line top-ups; in other embodiments, the off-line top-up risk management parameter may be increased by resetting the cumulative total of the amounts of off-line top-ups that have been performed in the mobile telephone 102. In still other embodiments, the off-line top-up risk management parameter may be expressed as a single monetary amount that is increased in an online risk management parameter adjustment transaction like that illustrated in blocks 508-516, and that is decreased to reflect each off-line top-up transaction performed in the mobile telephone 102.

Considering again decision block 512, if in that decision block the server computer 106 determines that the risk management rule(s) applicable to the user do (does) not permit off-line top-ups in the mobile telephone 102, then the process of FIG. 5 branches at decision block 512 so as to end (as indicated at 518) without instructing the mobile telephone 102 to adjust the off-line top-up risk management parameter.

Considering again decision block 504, if in that decision block the server computer 106 determines that the user's account is not in a condition to support the requested top-up, then the process of FIG. 5 branches from decision block 504 to block 520. At block 520, the server computer 106 declines the requested online top-up transaction, and sends a message to that effect to the mobile telephone 102.

As the process is presented in FIG. 5, it is implied that the server computer 106 may send two messages to the mobile telephone 102 in performing the process, with one message containing a script to be executed by the payment application in mobile telephone 102 for increasing an upper cumulative limit for off-line purchase transactions, and with the other message containing instructions for the payment application to adjust the off-line top-up risk management parameter so as to permit future off-line top-ups. This implied scenario may indeed be the case, and the instructions in the second message may be in the form of a second script to be executed by the payment application in the mobile telephone 102 for the purpose of adjusting the off-line top-up risk management parameter. Either of these two messages may be sent before the other. However, in other embodiments, the server computer 106 may send just one message to the mobile telephone 102, with that message containing both scripts. In still other embodiments, the message may include a single script that, when executed by the payment application in the mobile telephone 102, results both in increasing the upper cumulative limit for off-line purchase transactions and in adjusting the off-line top-up risk management parameter so as to permit future off-line top-ups. This single script may include two parts, of which one is concerned with the current top-up (increasing the upper cumulative limit for off-line purchase transactions), while the other part is concerned with permitting future off-line top-ups (by adjusting the off-line top-up risk management parameter). As used herein and in the appended claims, the term “script” should be understood to refer to a part of a script, as well as to a whole script.

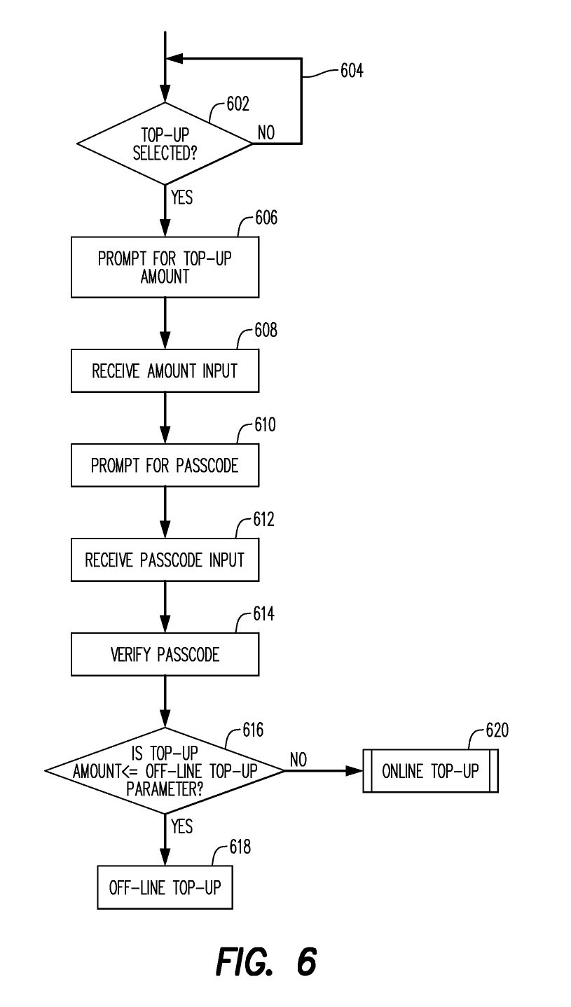

FIG. 6 is a flow chart that illustrates a process that may be performed in the mobile telephone 102 in accordance with aspects of the present invention.

At 602 in FIG. 6, the mobile telephone 102 determines whether the user has indicated that he/she wishes to request a top-up for the mobile telephone's pre-authorized payment capability. For example, the mobile telephone 102 may receive an indication to this effect as a result of the user providing input to the mobile telephone by selecting an item in a menu presented by a user interface provided by the mobile telephone 102. Such a menu, for example, may be presented by a “wallet” function that the user has accessed in the mobile telephone 102.

As indicated by branch 604 from 602, the process of FIG. 6 may idle at 602 until the user indicates that a top-up should be requested. However, once the mobile telephone 102 receives such an indication, then the process of FIG. 6 advances from 602 to 606.

At 606, the mobile telephone 102 prompts the user to enter a monetary amount by which the pre-authorized balance is to be topped-up. This may be done, for example, by displaying one or more messages on the display 310 (FIG. 3) of the mobile telephone 102. For example, the user may be prompted to select a menu item, and/or to enter numerical data via the keypad 312 or by operating another input device included in the mobile telephone.

In some embodiments, step 606 may also include the mobile telephone presenting to the user—via the user interface—information that indicates the current balance available in the mobile telephone for pre-authorized transactions, while at the same time asking the user to select/input a monetary amount for the top-up request.

Step 608 follows step 606. At step 608, the mobile telephone receives, from the user, input to designate the monetary amount for the top-up request. This may occur via the user interacting with the user interface.

Step 608 is followed by step 610. At step 610 the mobile telephone 102 prompts the user to enter his/her passcode. This may occur via the user interface, and is a security measure to reduce the possibility of unauthorized use of the mobile telephone 102 for payment purposes. More specifically, the user may enter the passcode by operating the keypad 312 or another input device included in the mobile telephone 102. At step 612, the mobile telephone receives the user's input of the passcode, and at 614 the mobile telephone 102 verifies the correctness of the passcode entered by the user. Both of these steps may entail cooperation between the payment application and the user interface.

In some embodiments, the payment application may limit the number of times the user may attempt to enter the passcode correctly, as described, for example, in the above-referenced '703 patent application.

Although the above steps 606-614 have been presented in the drawing and discussed above in a certain order, it should be understood that this order may be varied. For example, in some embodiments, the passcode may be entered and verified before the monetary amount for the top-up is entered.

Following steps 606-614, the process advances to a decision block 616. At decision block 616, the mobile telephone 102 determines whether the amount of the top-up requested by the user is less than or equal to the off-line top-up risk management parameter as currently stored in the mobile telephone 102. If such is the case, then the process of FIG. 6 advances from decision block 616 to block 618, which represents an off-line top-up procedure. In other words, the mobile telephone 102 compares the requested amount of the top-up with the off-line top-up risk management parameter, and determines, based on a result of the comparison, whether to execute the requested top-up request off-line without communication with the server computer 106.

In block 618, the payment application in the mobile telephone 102 increases the available balance for pre-authorized off-line purchase transactions. At the same time, the payment application adjusts the off-line top-up risk management parameter to reflect the off-line top-up that has just been performed. For example, the cumulative amount of off-line top-up transactions may be increased to reflect the current top-up.

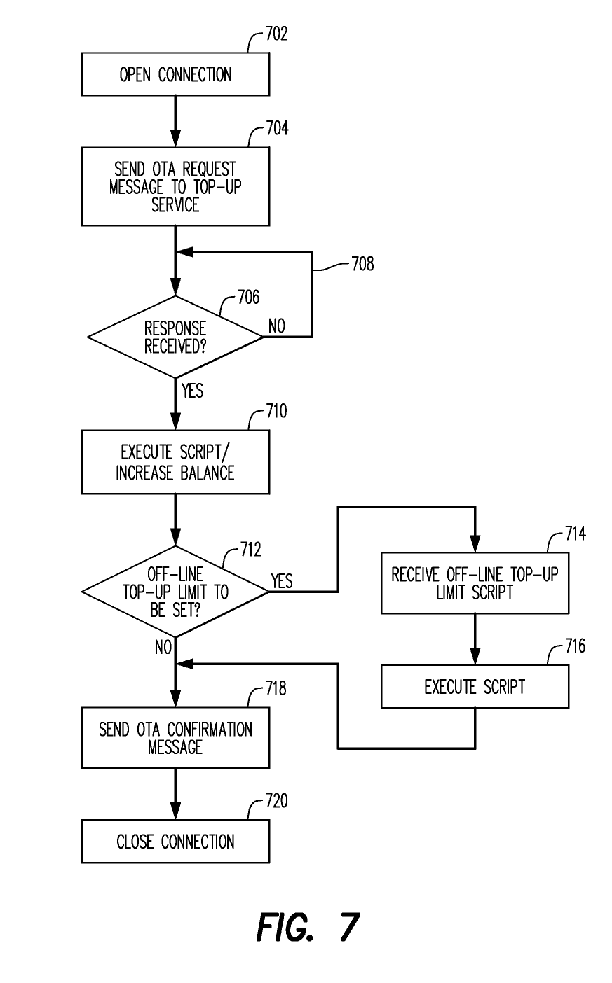

Considering again decision block 616, if the mobile telephone 102 makes a negative determination (i.e., if the mobile telephone 102 determines that the amount of the requested top-up is greater than the off-line top-up risk management parameter), then the process of FIG. 6 branches from decision block 616 to block 620. (It will be appreciated that the mobile telephone 102 may make a negative determination at decision block 616 if, for example, the off-line top-up risk management parameter currently has the value “0”, which would indicate that all permitted off-line top-ups have already occurred. Alternatively, the off-line top-up risk management parameter may be permanently set to “0”, reflecting a decision by the issuer/server computer 106 that off-line top-ups are not appropriate for the user in question.) Block 620 represents an online top-up procedure. In conjunction with FIG. 5, there has already been described herein an example of how the server computer 106 may operate in connection with an online top-up procedure. Now, and with reference to FIG. 7, there will be presented a description of how the mobile telephone 102 may operate in connection with an online top-up procedure.

Turning then to FIG. 7, at block 702 the mobile telephone opens an OTA messaging connection (e.g., a GPRS connection) with the server computer 106. In connection with this step, for example, the mobile telephone 102 may access the “http” address of the server computer 106. Next, at 704, the mobile telephone 102 sends an OTA message to the server computer 106 to request the top-up desired by the user. This message may, for example, include a cryptogram that the mobile telephone/payment application calculated before sending the message. The message may also include the monetary amount for the top-up as specified by the user.

Decision block 706 follows step 704. At 706, the mobile telephone determines whether it has received an OTA response to the top-up request from the server computer 106. As indicated by branch 708 from decision block 706, the process of FIG. 7 may idle until the response from the server computer 106 is received. (In some embodiments, the process of FIG. 7 may time out and abort if the response is not received within a predetermined period of time after the top-up request is sent.)

When the OTA response from the server computer 106 is received, the process of FIG. 7 advances from decision block 706 to block 710. (The ensuing description assumes that the response from the server computer 106 indicates that the top-up was authorized. If such is not the case, then the process of FIG. 7 may abort upon receiving the response from the server computer 106.) At 710, the payment application in the mobile telephone 102 executes a script contained in the response (for example, such as the script discussed above in connection with block 506), thereby effecting an increase in the pre-authorized balance stored in the mobile telephone 102. For example, execution of the script may increase the upper cumulative off-line purchase transaction amount stored in the payment application.

The process of FIG. 7 advances from block 710 to decision block 712. At decision block 712, the mobile telephone 102 determines whether this online transaction with the server computer 106 is also to include adjustment of the off-line top-up risk management parameter. For example, the mobile telephone 102 may make this determination based on an indication (e.g., a flag) provided by the server computer 106 in the response to the top-up request or in a subsequent message from the server computer 106 during the current online top-up transaction.

If the mobile telephone 102 makes a positive determination at decision block 712, then the process of FIG. 7 advances from the decision block 712 to block 714. At block 714, the mobile telephone 102 receives from the server computer 106 a script for adjusting the off-line top-up risk management parameter. Then, at block 716, the mobile telephone 102 executes the script received at 714. As discussed above in connection with block 516, in executing the script received at 714, the mobile telephone 102 sets the off-line top-up risk management parameter so as to permit a certain cumulative amount of future off-line top-ups in the mobile telephone 102. This may include, for example, increasing the cumulative limit on off-line top-ups, or re-setting the cumulative total of off-line top-ups that have previously been performed.

Block 716 is followed by block 718. At 718, the mobile telephone 102 transmits a confirmation message (as an OTA message) to the server computer 106. The confirmation message may include updated values of the risk management parameters, a script counter and a cryptogram generated by the payment application. This message may thus confirm to the server computer 106 that the mobile telephone 102 properly executed the script or scripts. After sending the confirmation message, the mobile telephone 102 may close the OTA connection to the server computer 106, as indicated at 720 in FIG. 7.

Considering again decision block 712, if the mobile telephone 102 makes a negative determination at that decision block (i.e., if no adjustment to the off-line top-up risk management parameter is in the offing), then the process of FIG. 7 may branch directly from the decision block 712 to blocks 718 and 720.

In some embodiments, the interaction between the user and the mobile telephone 102 may be essentially the same for both off-line and online top-up transactions. Indeed, the user may not even be able to discern whether the top-up transaction is off-line or online, except possibly that the user may notice a brief delay for online top-up transactions to accommodate the OTA communication between the mobile telephone 102 and the server computer 106.

Up to this point in the discussion, the invention has been described in the context of employing a payment-enabled mobile telephone as the payment device. However, it may alternatively be the case that the payment device may be in a different form, including for instance a contact or contactless IC payment card. In the latter cases, the payment device may engage in online top-up transactions (including possibly setting of off-line top-up risk management parameters) via a terminal (not shown) with which the payment device may be interfaced via contacts on the device or via contactless short-range communication. Further, such payment devices may be interfaced to terminals to allow interaction with users, via a user interface made available with the terminal, for the purpose of top-up transactions that may be off-line (not requiring communication with the server 106) rather than online.

Although the server computer 106 is portrayed in the above description as a single computer, it may in practice be constituted by two or more computers.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, the term “OTA” or “over-the-air” should be understood to refer to an exchange of data messages via at least one mobile telephone network, and more specifically calls for transmission of data (in either or both directions) between a mobile telephone and a cellular communications base station.

The flow charts and descriptions thereof herein should not be understood to prescribe a fixed order of performing the method steps described therein. Rather the method steps may be performed in any order that is practicable.

As used herein and in the appended claims, the term “payment card system account” includes a credit card account or a deposit account that the account holder may access using a debit card. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card or a debit card.

As used herein and in the appended claims, the term “payment card system” refers to a system for handling purchase transactions and related transactions and operated under the name of MasterCard, Visa, American Express, Diners Club, Discover Card or a similar system. In some embodiments, the term “payment card system” may be limited to systems in which member financial institutions issue payment card accounts to individuals, businesses and/or other organizations.

While it is believed that the distinction between off-line purchase transactions and off-line top-up transactions will be clear to those who are skilled in the art, it will now be reiterated that the former entail purchases from and interactions with retailers or merchants, whereas the latter do not. The terms “off-line top-up transactions” and “off-line top-ups” should be understood as being equivalent to each other.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method of operating a payment device, the method comprising:
prompting a user to enter a monetary amount for a top-up request;
receiving user input into the payment device, said user input indicative of the monetary amount;
prompting the user to enter a passcode;
receiving, in the payment device, user input of the passcode;
verifying the passcode;
comparing the monetary amount with a risk management parameter; and
based on a result of said comparing step, determining in the payment device whether to execute said top-up request off-line within the payment device.

2. The method of claim 1, wherein the determining step includes determining that an off-line top-up is permitted;
the method further comprising:
performing an off-line top-up in the mobile telephone whereby a pre-authorized balance in the payment device is increased.

3. The method of claim 2, wherein the off-line top-up includes increasing an upper cumulative limit for pre-authorized purchase transactions by the mobile telephone.

4. The method of claim 2, wherein the off-line top-up includes adjusting said risk management parameter by increasing an off-line cumulative top-up amount.

5. The method of claim 1, wherein said risk management parameter is a difference between an upper cumulative limit for off-line top-ups and an off-line cumulative top-up amount.

6. The method of claim 1, wherein the determining step includes determining that an off-line top-up is not currently permitted;
the method further comprising:
engaging in an online top-up transaction wherein the payment device exchanges communications with a server computer;
receiving a script from said server computer; and
executing said script in the payment device to adjust said risk management parameter so as to permit future off-line top-ups in the payment device.

7. The method of claim 6, wherein said risk management parameter is adjusted by increasing an upper cumulative limit for off-line top-ups.

8. The method of claim 6, wherein said risk management parameter is adjusted by re-setting an off-line cumulative top-up amount.

9. The method of claim 6, wherein:
said script is a first script; and
said online top-up transaction includes the payment device receiving a second script from the server computer, and the payment device executing said second script to increase a pre-authorized balance in the payment device.

10. The method of claim 9, wherein said second script is executed before said first script.

11. The method of claim 9, wherein said first script is executed before said second script.

12. The method of claim 1, wherein the payment device is a payment-enabled mobile telephone.

13. The method of claim 1, wherein the off-line top-up includes adjusting said risk management parameter by increasing an off-line cumulative top-up amount.

14. A method of operating at least one server computer, the method comprising:
receiving a top-up request that originated from a payment device;
authorizing the top-up request;
accessing account information that pertains to a user of the payment device;
accessing at least one risk management rule;
based on the account information and the at least one risk management rule, the at least one server computer determining whether to permit off-line top-ups in the payment device; and
in an event that said at least one server computer determines that off-line top-ups are permitted in the payment device, the top-up server computer responding to said top-up request by downloading instructions to said payment device to set a risk management parameter in said payment device so as to permit off-line top-ups in the payment device.

15. The method of claim 14, further comprising:
the at least one server computer determining a value at which to set said risk management parameter based on the account information and the at least one risk management rule.

16. The method of claim 14, wherein said instructions instruct the payment device to increase an upper cumulative limit for off-line top-ups.

17. The method of claim 14, wherein said instructions instruct the payment device to reset an off-line cumulative top-up amount.

18. The method of claim 14, wherein:
the payment device is a payment-enabled mobile telephone; and
the top-up server computer receives the top-up request and downloads the instructions via over-the-air communication with the payment-enabled mobile telephone.

19. An article of manufacture, comprising:
a computer readable medium having computer readable program code means therein for determining whether to perform an off-line top-up or to perform an online top-up in a payment device, the computer readable program code means in said article of manufacture comprising:
computer readable program code means for prompting a user to enter a monetary amount for a top-up request;
computer readable program code means for receiving user input into the payment device, said user input indicative of the monetary amount;
computer readable program code means for prompting the user to enter a passcode;
computer readable program code means for receiving, in the payment device, user input of the passcode;
computer readable program code means for verifying the passcode;
computer readable program code means for comparing the monetary amount with a risk management parameter; and
computer readable program code means for, based on a result of said comparing step, determining in the payment device whether to execute said top-up request off-line within the payment device.

20. The article of manufacture of claim 19, wherein the determining step includes determining that an off-line top-up is permitted;
the computer readable program code means in said article of manufacture further comprising:
computer readable program code means for performing an off-line top-up in the mobile telephone whereby a pre-authorized balance in the payment device is increased.

21. The article of manufacture of claim 19, wherein the determining step includes determining that an off-line top-up is not currently permitted;
the computer readable program code means in said article of manufacture further comprising:
computer readable program code means for engaging in an online top-up transaction wherein the payment device exchanges communications with a server computer;
computer readable program code means for receiving a script from said server computer; and
computer readable program code means for executing said script in the payment device to adjust said risk management parameter so as to permit future off-line top-ups in the payment device.
